(19) United States
(12) Patent Application Publication
(10) Pub. No.: US 2008/0151478 A1
(43) Pub. Date: Jun. 26, 2008

(54) HINGE FOR LAPTOP COMPUTER

(76) Inventor: Jr-Jiun Chern, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/614,460

(22) Filed: Dec. 21, 2006

(51) Int. Cl. G06F 1/16; E05C 17/64

(52) U.S. Cl. 361/681; 16/342

(57) ABSTRACT

A hinge includes a first connector, a casing, a bush and a second connector. The first connector includes a post and a beam extended from the post. The post can be connected to a portion of a laptop computer. The casing is non-rotationally mounted on the beam. The bush is disposed non-rotationally in the casing. The second connector includes a shaft and a plate extended from the shaft. The shaft is rotationally inserted in the bush. The plate can be connected to another portion of the laptop computer.

### BACKGROUND OF INVENTION

1. Field of Invention

The present invention relates to a hinge and, more particularly, to a hinge for use in a laptop computer.

2. Related Prior Art

Referring to FIG. 8, a conventional hinge includes a first connector 1, a lining 2, a bush 3 and a second connector 4. The first connector 1 includes a post and a socket extended from the post. The post of the first connector 1 is connected to a host of a laptop computer. The lining 2 is fit in the socket of the first connector 1. The bush 3 is an arched elastic strip. The bush 3 is fit in the lining 2. The second connector 4 includes a plate and a shaft extended from the plate. The shaft of the second connector 4 is inserted in the lining 2. The plate of the second connector 4 is connected to a liquid crystal display (“LCD”) of the laptop computer. The bush 3 damps the rotation of the shaft of the second connector 4 as the LCD is pivoted towards the host. It however requires high precision in making the first connector 1 and the lining 2 so that the lining 2 can be fit in the socket of the first connector 1.

There are hinges in which the lining 2 is omitted. However, the size of the first connector 1 is determined by that of the second connector 4. More particularly, the size of the socket of the first connector 1 is determined by that of the shaft of the second connector 4. Therefore, different first connectors are used for different second connectors. As the first connectors are made by molding, different sets of molds are used. It is more expensive to mold different first connectors than mold a common first connector and make different linings.

The present invention is therefore intended to obviate or at least alleviate the problems encountered in prior art.

### SUMMARY OF INVENTION

According to the present invention, a hinge includes a first connector, a casing, a bush and a second connector. The first connector includes a post and a beam extended from the post. The post can be connected to a portion of a laptop computer. The casing is non-rotationally mounted on the beam. The bush is disposed non-rotationally in the casing. The second connector includes a shaft and a plate extended from the shaft. The shaft is rotationally inserted in the bush. The plate can be connected to another portion of the laptop computer.

An advantage of the hinge according to the present invention is a low cost because the first connector and the casing can easily be made and connected to each other.

Another advantage of the hinge according to the present invention is high throughput because the first connector and the casing do not cause damage to each other during their joining together.

Other advantages and features of the present invention will become apparent from the following description referring to the drawings.

### BRIEF DESCRIPTION OF DRAWINGS

The present invention will be described through detailed illustration of two embodiments referring to the drawings.

FIG. 1 is a perspective view of a hinge according to the first embodiment of the present invention.

FIG. 2 is an exploded view of the hinge shown in FIG. 1.

FIG. 3 is a cross-sectional view of the hinge taken along a line 3-3 shown in FIG. 1.

FIG. 4 is a perspective view of a laptop computer equipped with two hinges as shown in FIGS. 1 through 3.

FIG. 5 is a perspective view of a hinge according to the second embodiment of the present invention.

FIG. 6 is an exploded view of the hinge shown in FIG. 5.

FIG. 7 is a cross-sectional view of the hinge taken along a line 7-7 shown in FIG. 5.

FIG. 8 is an exploded view of a conventional hinge.

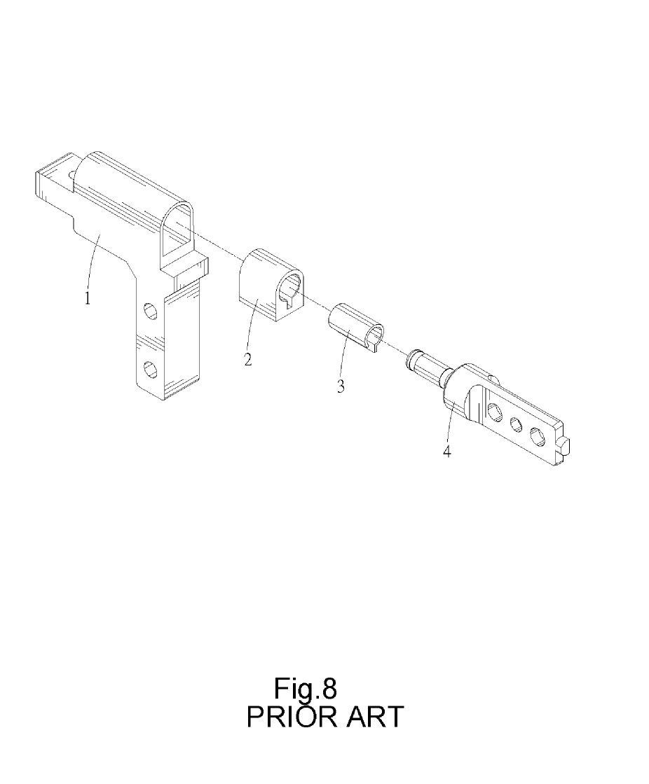

### DETAILED DESCRIPTION OF EMBODIMENTS

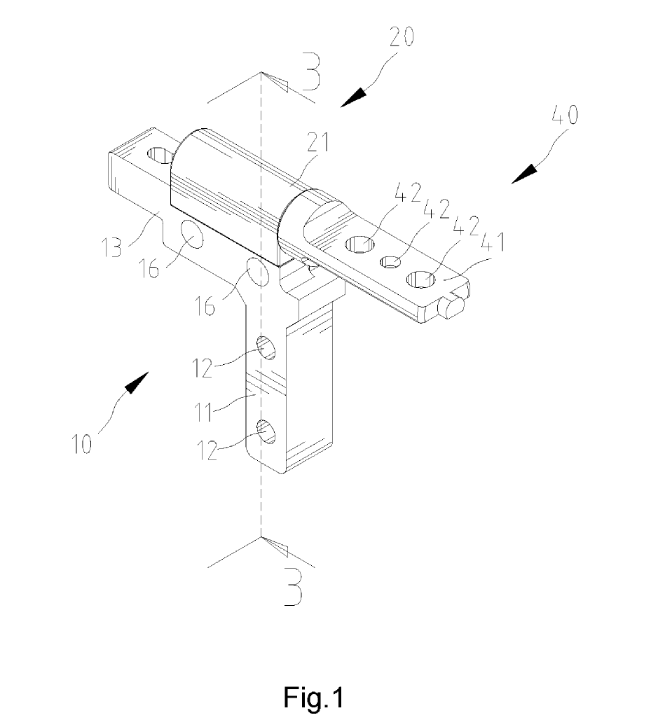

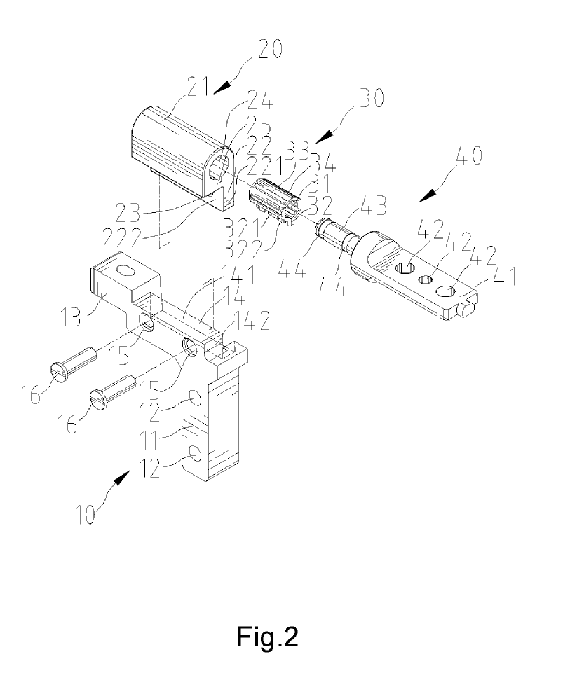

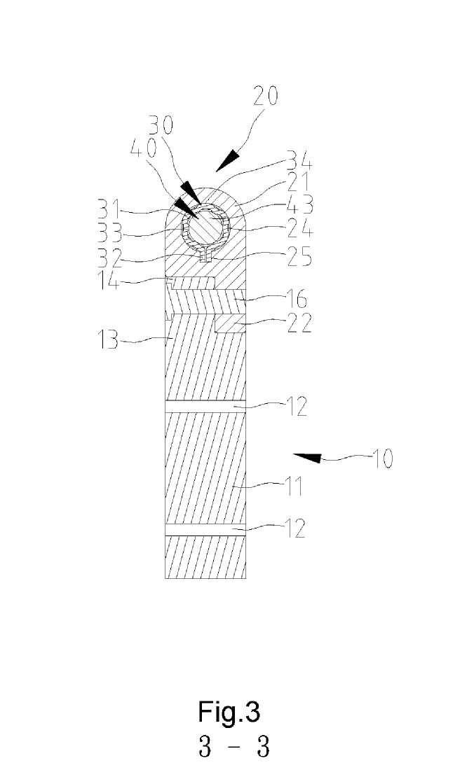

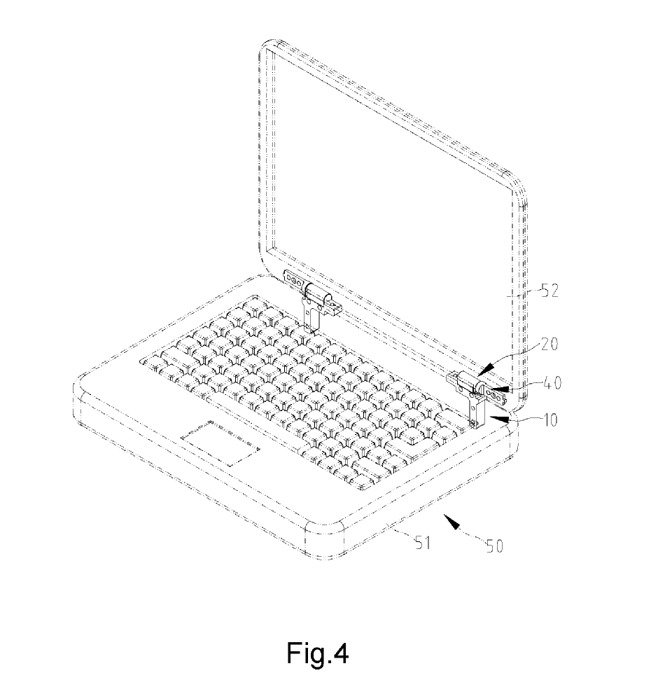

Referring to FIGS. 1 through 3, there is shown a hinge according to a first embodiment of the present invention. The hinge can be used in a laptop computer 50 including a host 51 and a liquid crystal display (“LCD”) 52 as shown in FIG. 4. The hinge includes a first connector 10, a casing 20, a bush 30 and a second connector 40.

The first connector 10 includes a post 11, a beam 13 transversely extended from the post 11 and a connective device 14 formed on the beam 13. The connective device 14 includes a wall 141 and a cutout 142 next to the wall 141. Two apertures 15 are defined in the wall 141.

The casing 20 includes a tube 21 and a connective device 22 extended from the tube 21. The tube 21 defines a space 24 along the axis and a groove 25 in communication with the space 24. The connective device 22 includes a wall 221 and a cutout 222 near the wall. Two apertures 23 are defined in the wall 221.

The bush 30 includes a sleeve 31 and a positioning device 32 formed on the sleeve 31. A metal strip is rolled into the sleeve 31, with two edges made into the positioning device 32. The positioning device 32 includes pairs of tabs 321 and pairs of tabs 322. The tabs 321 extend parallel to each other. The tabs 36 are in contact with each other at an end but separated from each other at another end. The external side of the bush 30 is of a substantially polygonal form with corners 34 when it is viewed in the axial direction. The corners 34 are rounded. A trough 33 is defined between any two adjacent ones of the corners 34. Damping oil is filled in the troughs 33.

The second connector 40 includes a plate 41 and a shaft 43 axially extended from the plate 41. The plate 41 defines three apertures 42 through which fasteners can be driven into the LCD 52 for connecting the plate 41 to the LCD 52. The shaft 43 defines two annular grooves 44 for receiving damping oil.

The wall 141 is disposed in the cutout 222 while the wall 221 is located in the cutout 142. The walls 141 and 221 are located against each other. Fasteners 16 such as rivets are driven into the apertures 15 and 23 so that the first connector 10 is connected to the casing 20.

The sleeve 31 is located in the space 24. The positioning device 32 is disposed in the groove 25. Thus, the bush 30 is non-rotationally disposed in the tube 21. The rounded corners 34 are in contact with the wall of the space 24 of the tube 21.

The shaft 43 is disposed rotationally in and wrapped by the sleeve 31. Damping oil is provided between the shaft 43 and the sleeve 31 for damping the rotation.

Referring to FIG. 4, the laptop computer 50 is equipped with two hinges as described referring to FIGS. 1 through 3.

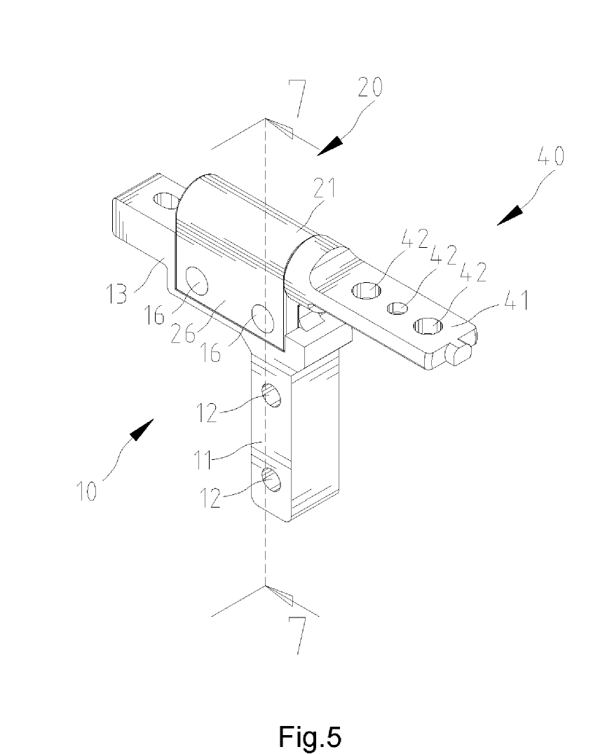

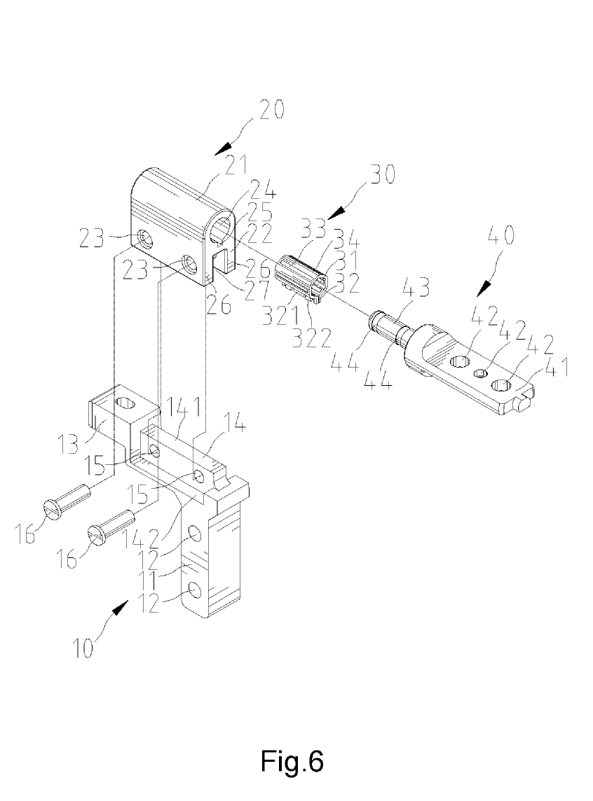

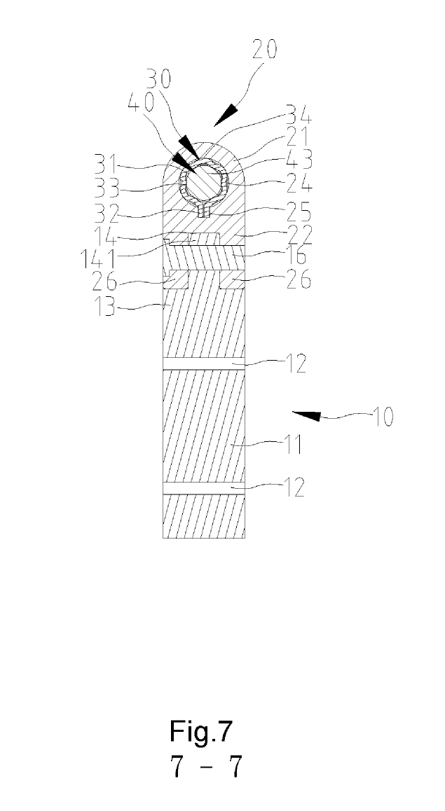

Referring to FIGS. 5 through 7, there is shown a hinge according to a second embodiment of the present invention. The second embodiment is like the first embodiment except two things. Firstly, the connective device 14 includes a wall 141 between two cutouts 142. Secondly, the connective device 22 includes two walls 26 extended from the tube 21 and a cutout 27 defined between the walls 26. Each of the walls 26 defines two apertures 23.

The wall 141 is disposed in the cutout 27 while the walls 26 are located in the cutouts 142. The wall 141 is sandwiched between the walls 26. Fasteners 16 such as rivets are driven into the apertures 15 and 23 so that the first connector 10 is connected to the casing 20.

The hinge according to the present invention exhibits at least two advantages. Firstly, the cost is low because the first connector 10 and the casing 20 can easily be made and connected to each other. Secondly, the throughput is high because the first connector 10 and the casing 20 do not damage to each other during their joining together.

The present invention has been described via the detailed illustration of the embodiments. Those skilled in the art can derive variations from the embodiments without departing from the scope of the present invention. Therefore, the embodiments shall not limit the scope of the present invention defined in the claims.

What is claimed is:

1. A hinge comprising:
a first connector comprising a post for connection to a portion of a laptop computer and a beam extended from the post;
a casing non-rotationally mounted on the beam;
a bush non-rotationally disposed in the casing; and
a second connector comprising a shaft rotationally inserted in the bush and a plate extended from the shaft for connection to another portion of the laptop computer.

2. The hinge according to claim 1 wherein the first connector comprises a connective device on the beam, and the casing comprises a connective device connected to the connective device of the first connector.

3. The hinge according to claim 2 wherein the connective device of the first connector comprises a wall, and the connective device of the casing comprises at least one wall connected to the wall of the connective device of the first connector.

4. The hinge according to claim 3 wherein the connective device of the casing comprises two walls for sandwiching the wall of the connective device of the first connector.

5. The hinge according to claim 3 comprising at least one fastener for connecting the wall of the connective device of the first connector to the wall of the connective device of the casing.

6. The hinge according to claim 5 wherein the fastener is a rivet.

7. The hinge according to claim 6 wherein the wall of the connective device of the first connector defines an aperture for receiving the rivet, and the wall of the connective device of the casing defines an aperture for receiving the rivet.

8. The hinge according to claim 1 wherein the casing defines a space and a groove in communication with the space, and the bush comprises a sleeve inserted in the space and a positioning device inserted in the groove.

9. The hinge according to claim 8 wherein the positioning device comprises at least one pair of parallel tabs.

10. The hinge according to claim 8 wherein the positioning device comprises at least one pair of diverged tabs.

11. The hinge according to claim 8 wherein the positioning device comprises at least one pair of parallel tabs and at least one pair of diverged tabs.

12. The hinge according to claim 8 wherein the sleeve comprises a polygonal from when it is viewed in a longitudinal direction.

13. The hinge according to claim 12 wherein the sleeve comprises rounded corners in contact with an internal side of the casing.

14. The hinge according to claim 1 wherein the shaft defines at least one annular groove for containing damping oil.

15. The hinge according to claim 14 wherein the shaft defines two annular grooves.
